(19) United States
(12) Patent Application Publication
(10) Pub. No.: US 2024/0284982 A1
(43) Pub. Date: Aug. 29, 2024

(54) E-VAPING DEVICE INCLUDING TWO-PIECE RIGID AIRWAY

(71) Applicant: NJOY, LLC, Scottsdale, AZ (US)

(72) Inventors: Josh NELSON, Madison, WI (US); Aj HACKERT, Elkhart Lake, WI (US)

(73) Assignee: NJOY, LLC, Scottsdale, AZ (US)

(21) Appl. No.: 18/588,483

(22) Filed: Feb. 27, 2024

Related U.S. Application Data
(60) Provisional application No. 63/487,169, filed on Feb. 27, 2023.
(60) Provisional application No. 63/487,175, filed on Feb. 27, 2023.
(60) Provisional application No. 63/487,180, filed on Feb. 27, 2023.

(51) Int. Cl. A24F 40/48; A24F 40/10; A24F 40/42; A24F 40/46; A24F 40/51; H05B 3/42

(52) U.S. Cl. CPC A24F 40/48; A24F 40/10; A24F 40/42; A24F 40/46; A24F 40/51; H05B 3/42

(57) ABSTRACT

An e-vaping device includes a heating base coupled to provide power for the e-vaping device, a flexible seal, and a two-piece rigid airway tube coupled to the heating base by the flexible seal, the two-piece rigid airway tube forming an airpath providing an inhalable dispersion. The e-vaping device also includes a heating assembly housed within the two-piece rigid airway tube. The heating assembly includes a wick in fluid communication with a tank holding a pre-vapor formulation, and a heating element configured to heat the pre-vapor formulation in the wick to generate the inhalable dispersion.

### CROSS-REFERENCE TO RELATED APPLICATION

This application claims benefit under 35 U.S.C. 119(e) of the following prior-filed U.S. Provisional Applications, each of which is incorporated herein by reference in its entirety for all purposes: U.S. Provisional Application No. 63/487,169 entitled, “Method For Joining Circuits For Automated Assembly,” filed on Feb. 27, 2023; U.S. Provisional Application No. 63/487,175 entitled, “Stamped Atomizer Technology,” filed on Feb. 27, 2023; and U.S. Provisional Application No. 63/487,180 entitled, “Simplified Cartomizer Geometry,” filed on Feb. 27, 2023.

### BACKGROUND

### Field

The present disclosure relates to electronic vaping devices.

### Description of Related Art

An electronic vaping (“e-vaping”) device generally includes an on-board power source, such as a battery, which is electrically connected to a heating element that converts a pre-vapor formulation stored in a cartridge to a vapor. The vapor exits the e-vaping device through a mouthpiece including at least one outlet. E-vaping devices are generally either disposable as a unit, in which case the pre-vapor formulation is housed in the disposable unit, or partially disposable, in which case a re-usable battery section can be attached to disposable cartridges housing the pre-vapor formulation.

### SUMMARY

Various example embodiments herein disclose an e-vaping device that uses a two piece rigid airway tube and a cylindrical absorbent to improve device robustness and reduce processes variability. In some example embodiments of e-vaping devices, the total particulate matter (TPM) can be increased, while at the same time reducing manufacturing time and scrap rate. For example, using a cylindrical absorbent may improve ease of manufacturing. And using a rigid atomizer holder and cover may better protect potentially fragile element/wick heating assemblies during manufacturing and use. Additionally, in some example embodiments an overall parts count and parts can be reduced, potentially making higher manufacturing tolerances possible.

In various example embodiment, an e-vaping device includes a heating base coupled to provide power for the e-vaping device, a flexible seal, a two-piece rigid airway tube coupled to the heating base by the flexible seal, wherein the two-piece rigid airway tube forms an airpath providing an inhalable dispersion, a heating assembly housed within the two-piece rigid airway tube, and the heating assembly including a wick in fluid communication with a tank holding a pre-vapor formulation and a heating element configured to heat the pre-vapor formulation in the wick to generate the inhalable dispersion. Optionally, a cylindrical absorbent surrounding at least a portion of the two-piece rigid airway tube may be included, wherein the cylindrical absorbent holds the pre-vapor formulation and provides the pre-vapor formulation to the wick.

In some such example embodiments the two-piece rigid airway tube includes a heating assembly cover, and a heating assembly holder including a first end engaging the heating assembly cover, and a second end distal from the first end engaging the flexible seal, wherein the first end of the heating assembly holder includes a first slot with the wick. The first end of the heating assembly holder may include a graduated adapter formed on an outer surface of the heating assembly holder.

In various example embodiments, the heating assembly cover includes a flared mating end engaging the heating assembly holder, a second slot in the flared mating end, wherein the second slot aligns with the first slot included in the heating assembly cover when the two-piece rigid airway tube is assembled. The heating assembly may include elongated conductive legs long enough to reach from a bottom of the first slot in the first end of the heating assembly holder to a bottom of the flexible seal.

In any or all of the above example embodiments, the e-vaping device may include a pressure sensor including electrical contacts, and mounted in a sensor cavity of the flexible seal, wherein the pressure sensor triggers power to the electrical contacts in response to a change in pressure indicating a requested draw, and wherein the elongated conductive legs are electrically coupled to the electrical contacts included in the pressure sensor. In some example embodiments, the electrical contacts included in the pressure sensor are located on an exposed face of the pressure sensor, the elongated conductive legs of the heating assembly include free ends distal from the wick, and a free end of at least one of the elongated conductive legs includes a 90 degree bend extending over the exposed face of the pressure sensor and directly contacting at least one of the electrical contacts on the exposed face of the pressure sensor to establish a solderless connection.

In various example embodiments, the electrical contacts included in the pressure sensor are located on an exposed face of the pressure sensor, the elongated conductive legs of the heating assembly include free ends distal from the wick, and wires attached to the electrical contacts on the exposed face of the pressure sensor are further attached to the free ends of the elongated conductive legs. The elongated conductive legs of the heating assembly may be formed as an integral part of a heating element included in the heating assembly, and may be formed as a unitary piece by a metal stamping process in some example embodiments.

In example embodiments, the flexible seal includes conductor passages holding the elongated conductive legs, allowing them to pass from a top of the seal to a bottom of the seal, and to seal around the elongated conductive legs. In some example embodiments, the flexible seal includes an air passage allowing air to flow through the air passage and into the airpath provided by the two-piece rigid airway tube. The flexible seal may also include a sensor cavity in fluid communication with the air passage, and holding a pressure sensor, a first sealing surface forming a first seal at an interface of the heating base and the flexible seal, a second sealing surface forming a second seal at an interface of the two-piece rigid airway tube and the flexible seal, and a third sealing surface forming a third seal at an interface of the air passage included in the flexible seal and the pressure sensor inserted into the sensor cavity.

Any or all of the above example embodiments may include an outer housing covering the heating base, the flexible seal, the two-piece rigid airway tube, and the cylindrical absorbent, wherein the outer housing and the two-piece rigid airway tube form a pre-vapor solution tank, and the flexible seal includes a plurality of elastic sealing ribs sealing the pre-vapor solution tank.

In various example embodiments an e-vaping device includes a two-piece rigid airway tube including a heating assembly holder and a heating assembly cover having mated ends slidingly engaged, and a heating assembly housed within the two-piece rigid airway tube proximate to the mated ends of the two-piece rigid airway tube.

In some example embodiments the e-vaping device also includes a cylindrical absorbent surrounding the two-piece rigid airway tube. The heating assembly may include a heating element and a wick, and the mating ends of the heating assembly holder and the heating assembly cover include slots, wherein in an assembled state, the slots included in the heating assembly holder and the heating assembly cover align to form a wick opening.

In some example embodiments, the e-vaping device includes a flexible seal coupled to a bottom end of the heating assembly holder. In some such embodiments, the heating element includes elongated conductive legs extending from the wick opening to a bottom of the flexible seal. The elongated conductive legs may be integral to the heating element.

In various example embodiments, electrical elements of an e-vaping device may be connected in a repeatable way that may eliminate and/or reduce the use of solder and/or manual manipulation during connection of elements. Various example methods and devices can be used to achieve and maintain alignment and electrical connection properties throughout handling during manufacturing, and/or product usage. Various example embodiments include lead-in alignments and snap lock features.

It will be appreciated that in the presence of e-liquids, materials used for electrical connections to a heating element may be important. Various example embodiments include devices, methods and connectors having a geometry of stamped and formed heating elements and contacts that may be easily guided together and locked into place, forming a solid electro-mechanical connection without using solder and/or resistance welding.

In various example embodiments, an e-vaping assembly includes a first electromechanical contact including a guide portion and a locking portion, and a second electromechanical contact including a complementary guide portion and a complementary locking portion, wherein the guide portion and the complementary guide portion cooperate to guide the first electromechanical contact into locking engagement with the second electromechanical contact, and the locking portion and the complementary locking portion cooperate to form a solderless electromechanical connection and lock the first electromechanical contact into a fixed position relative to the second electromechanical contact.

In some such example embodiments, the first electromechanical contact includes a first flattened, elongated end forming a V-shaped portion having two sides, wherein at least one of the two sides includes a guide opening, and the second electromechanical contact includes a second flattened and elongated end, wherein the second flattened and elongated end includes a slot having a first complementary side, a back side, a second complementary side, and an open side, wherein the first complementary side is tapered to slide into the guide opening of the first electromechanical contact.

In an example embodiment, at least one of the two sides of the V-shaped portion is a free side, and has an engagement length measured from a bottom of the V-shaped portion to a termination of the free side, and wherein the V-shaped portion is elastically compressible; and the second complementary side includes a protrusion extending into the slot, wherein a distance from the back side of the slot to the protrusion matches the engagement length of the free side, and wherein as the V-shaped portion elastically compresses in response to being guided into the slot by the guide opening sliding over the tapered, first complementary side, and the protrusion snaps over the termination of the free side in response to the first electromechanical contact reaching a locking engagement position.

In other example embodiments, the first electromechanical contact includes a sleeve, wherein the sleeve includes an elastically compressible tab extending from an inner surface of the sleeve, and the second electromechanical contact includes a blade having through hole formed therein, wherein the blade is sized to fit snugly within the sleeve, and the elastically compressible tab springs into locking engagement with the through hole in response to the first electromechanical contact reaching a locking engagement position.

The first electromechanical contact may be constructed of a first conductive material, and the second electromechanical contact is constructed of a second conductive material different from the first conductive material. In some such example embodiments, the first electromechanical contact is constructed of a nickel chromium alloy, and the second electromechanical contact is constructed of gold plated brass. The first electromechanical contact may be integral to a heating element included in the heating assembly, and the second electromechanical contact may be attached to a heating assembly holder.

In some example embodiments, a method of assembling elements of an e-vaping device includes guiding a first electromechanical contact into locking engagement with a second electromechanical contact using a guide portion of the first electromechanical contact and a complementary guide portion of the second electromechanical contact, wherein the first electromechanical contact is integral to a first e-vaping element, and the second electromechanical contact is attached to a second e-vaping element, and urging a locking portion of the first electromechanical contact and a complementary locking portion of the second electromechanical contact into locking engagement.

In some example embodiments, the guiding includes guiding a tapered side of a slot formed in an elongated end of the second electromechanical contact into a guide opening in a side of a V-shaped portion of the first electromechanical contact. Various example embodiments include urging the V-shaped portion of the first electromechanical contact into the slot formed in the elongated end of the second electromechanical contact until a free side of the V-shaped portion snaps under a protrusion in the slot in response to the first electromechanical contact reaching a locking engagement position.

Some example embodiments include sliding a sleeve of the first electromechanical contact including an elastically compressible tab extending from an inner surface of the sleeve over a blade sized to fit snugly within the sleeve, wherein the elastically compressible tab springs into locking engagement with an opening included in the blade in response to the first electromechanical contact reaching a locking engagement position. Guiding the first electromechanical contact into locking engagement with the second electromechanical contact may also include connecting a heating element to a heating assembly holder.

In some example embodiments, an e-vaping device includes a heating element including first electromechanical contacts, wherein the heating element is configured to use power received through the first electromechanical contacts to generate an inhalable dispersion by heating a pre-vapor formulation stored in the e-vaping device, second electromechanical contacts held by a heating assembly holder, the second electromechanical contacts coupled to a power source, and wherein the first electromechanical contacts are locked to the second electromechanical contacts to form a solderless electromechanical connection.

In various example embodiments, the first electromechanical contacts include guide portions and locking portions, and the second electromechanical contacts include complementary guide portions and complementary locking portions, wherein the guide portions and the complementary guide portions cooperate to guide the first electromechanical contacts into locking engagement with the second electromechanical contacts, and the locking portions and the complementary locking portions cooperate to form a solderless electromechanical connection and lock the first electromechanical contacts into fixed positions relative to the second electromechanical contacts.

In some example embodiments, the first electromechanical contacts include first flattened, elongated ends forming a V-shaped portion having two sides, wherein at least one of the two sides includes a guide opening, and the second electromechanical contacts include second flattened and elongated ends, wherein the second flattened and elongated ends include slots having first complementary sides, back sides, second complementary sides, and open sides, wherein the first complementary sides are tapered to slide into the guide openings of the first electromechanical contacts.

In some or all of the above example embodiments, at least one of the two sides of the V-shaped portions is a free side having engagement lengths measured from bottoms of the V-shaped portion to a termination of the free side, and wherein the V-shaped portions are elastically compressible, and the second complementary sides include protrusions extending into the slots, wherein distances from the back sides of the slots to the protrusion matches the engagement lengths of the free sides, and wherein as the V-shaped portion elastically compresses in response to being guided into the slots by the guide openings, and the protrusions snap over the termination of the free side in response to the first electromechanical contact reaching a locking engagement position.

In other example embodiments, the first electromechanical contacts may include sleeves, wherein the sleeves include an elastically compressible tab extending from an inner surface of the sleeve, and the second electromechanical contacts include blades having a through hole formed therein, wherein the blades are sized to fit snugly within the sleeves, and the elastically compressible tabs spring into locking engagement with the through hole in response to the first electromechanical contacts reaching locking engagement positions.

In any or all of the above example embodiments, the first electromechanical contacts are constructed of a first conductive material, and the second electromechanical contacts are constructed of a second conductive material different from the first conductive material. The first electromechanical contacts may be constructed of a nickel chromium alloy, and the second electromechanical contacts may be constructed of gold plated brass. In various example embodiments, the first electromechanical contacts may be integral to the heating element.

### BRIEF DESCRIPTION OF THE DRAWINGS

The various features and advantages of the non-limiting embodiments herein may become more apparent upon review of the detailed description in conjunction with the accompanying drawings. The accompanying drawings are provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is an exploded view of an e-vaping device in accordance with various example embodiments;

FIG. 2 is a cutaway view of an e-vaping device in accordance with various example embodiments;

FIG. 3 is a perspective view of a portion of an internal e-vaping assembly, in accordance with various example embodiments;

FIG. 4 is an exploded view of a heating assembly solderlessly connected to power contacts included in a heating assembly holder, in accordance with various example embodiments;

FIG. 5 is a perspective view of a portion of an alternate internal e-vaping assembly, in accordance with various example embodiments;

FIG. 6 is an exploded view of a heating assembly solderlessly connected to power contacts included in a heating assembly holder, in accordance with various example embodiments;

FIG. 7 is an exploded perspective view of another internal e-vaping assembly, in accordance with various example embodiments with various example embodiments;

FIG. 8 is an exploded view of a heating assembly solderlessly connected to power contacts included in a heating assembly holder, in accordance with various example embodiments;

FIG. 9 is an exploded perspective view of an internal e-vaping assembly, in accordance with various example embodiments;

FIG. 10 is a see-through side view of an assembled e-vaping device in accordance with various example embodiments;

FIG. 11 is a perspective view of a portion of an internal e-vaping assembly, in accordance with various example embodiments;

FIG. 12 is an exploded view of an upper e-vaping assembly in accordance with various example embodiments;

FIG. 13A is perspective view of an upper e-vaping assembly in accordance with various example embodiments;

FIG. 13B is another perspective view of an upper e-vaping assembly in accordance with various example embodiments;

FIG. 14 is a perspective see-through view of an e-vaping device in accordance with various example embodiments;

FIG. 15 is an exploded view of an upper e-vaping assembly in accordance with various example embodiments;

FIG. 16 is a perspective see-through view of an e-vaping device in accordance with various example embodiments;

FIG. 17A is a cutaway view of an e-vaping device seal in accordance with various example embodiments; and

FIG. 17B is a cutaway view of an e-vaping device seal in accordance with various example embodiments.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

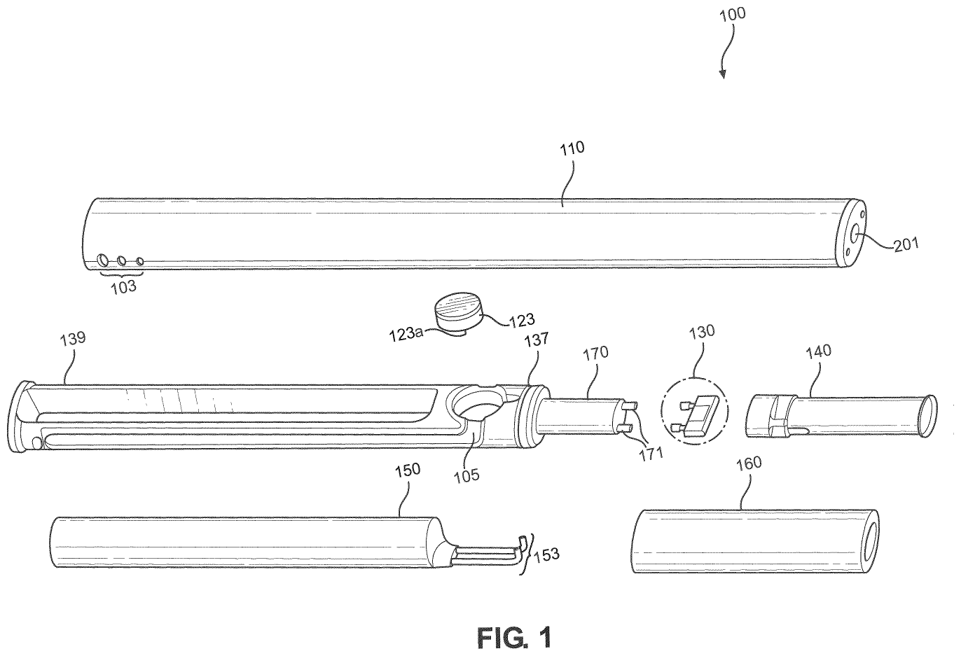

Referring to FIG. 1, an e-vaping device 100 will be discussed in accordance with various example embodiments. In various example embodiments, e-vaping device 100 includes rechargeable battery assembly 150 including power connectors/wires 153. Rechargeable battery assembly 150 may be housed in heating base 139, which may also house puff sensor 123, which detects negative pressure changes created when an e-vaping adult consumer draws through heating assembly cover 140. In at least one example embodiment, puff sensor 123 may include an air-flow sensor as described in U.S. Pat. No. 9,072,321 issued on Jul. 7, 2015 to Liu, the entire contents of which is incorporated herein by reference.

In some example embodiments, power connectors/wires 153 may be connected to one or more puff sensor contacts 123a when both rechargeable battery assembly 150 and puff sensor 123 are assembled together in heating base 139. The one or more puff sensor contacts 123a are also coupled to power contacts 171 through conductors (not illustrated) included in heating assembly holder 170. Heating assembly 130 is, in turn, electrically connected to power contacts 171. Heating base 139 may be mated to heating assembly holder 170 via seal 137, which seals heating base 139 from a tank storing pre-vapor formulation (not illustrated in this view).

In various example embodiments, heating assembly holder 170 mates with heating assembly cover 140 to form a two-piece rigid airway tube in which heating assembly 130 is housed. In some example embodiments, heating assembly 130 is connected to puff sensor 123, which is in turn connected to rechargeable battery assembly 150 and acts as a switch that provides power to heating assembly 130 when activated by a puff, or draw.

Heating base 139 may also include air channel 105, which forms part of an airpath allowing air to be drawn through one or more openings 103 of outer housing 110, over puff sensor 123, and through the two-piece rigid airway tube formed by assembly holder 170 and heating assembly cover 140. As air flows through the airpath and around heating assembly 130, heating assembly 130 heats a pre-vapor solution to generate an inhalable dispersion, which is entrained in the airflow and delivered to an e-vaping adult consumer via mouth end 201. As used herein, a mouth end refers to an end of a housing, cover, or the like, from which a e-vaping adult consumer draws an inhalable dispersion. By way of contrast, a mouth end is fully integrated into a housing, cover, or the like, while a mouthpiece is an individually distinguishable item that is part of an e-vaping device.

In some example embodiments, when the two-piece rigid airway tube and heating base 139 are placed inside the outer housing 110, a pre-vapor formulation tank is formed between the two-piece rigid airway tube and the outer housing 110. Seal 137 may prevent a liquid pre-vapor formulation from exiting the tank and flowing into heating base 139. In various example embodiments, the tank may be filled with pre-vapor formulation, which may be absorbed by heating assembly 130 and converted into an inhalable dispersion delivered via the two-piece rigid airway tube formed by assembly holder 170 and heating assembly cover 140. Optionally, various example embodiments may include cylindrical absorbent 160 configured to slide over the two-piece rigid airway tube and substantially fill the tank formed between the two-piece rigid airway tube and the outer housing 110.

In at least one example embodiment, cylindrical absorbent 160 may be a fibrous material including at least one of cotton, polyethylene, polyester, rayon and combinations thereof. The fibers may have a diameter ranging in size from about 6 microns to about 15 microns (e.g., about 8 microns to about 12 microns or about 9 microns to about 11 microns). The storage medium may be a sintered, porous or foamed material. Also, the fibers may be sized to be irrespirable and may have a cross-section which has a Y-shape, cross shape, clover shape or any other suitable shape. In at least one example embodiment, the reservoir 95 may include a filled tank lacking any storage medium and containing only pre-vapor formulation. U.S. application Ser. No. 18/411,538, filed Jan. 1, 2024 and entitled, “Electronic Vaping Device Including Transfer Pad With Oriented Fibers,” describes various example embodiments of e-vaping devices, including heating assemblies, absorbent materials, and the like, and is hereby incorporated herein by reference in its entirety.

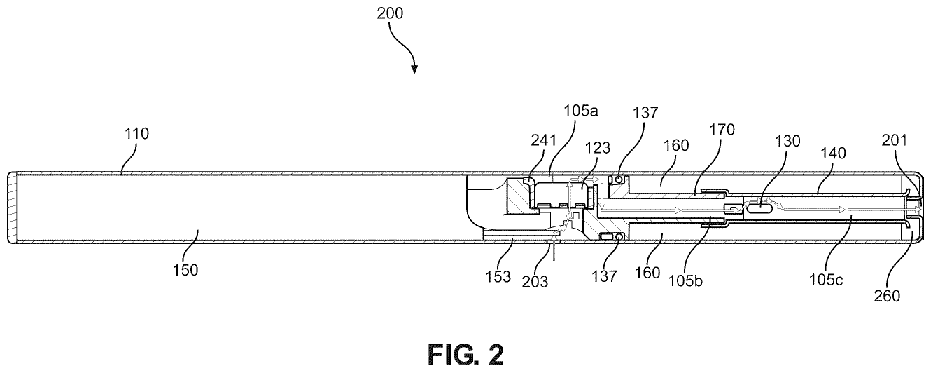

Referring next to FIG. 2 an e-vaping device 200 will be discussed in accordance with various example embodiments. E-vaping device 200 is an assembled view of the elements illustrated in FIG. 1, and various example embodiments includes outer housing 110, cylindrical absorbent 160 surrounding a two-piece rigid airway tube formed by heating assembly holder 170 and heating assembly cover 140. In at least some example embodiments, cylindrical absorbent 160 substantially fills a reservoir, or tank 260, formed between outer housing 110 and the two-piece rigid airway tube. E-vaping device 200 may also include heating assembly 1030, puff sensor 123, seal 137, puff sensor seal 241, and rechargeable battery assembly 150.

In some example embodiments, as illustrated by the white arrows in FIG. 2, in response to an e-vaping adult consumer drawing air at opening 201, air is pulled into air inlet(s) 203 in outer housing 110, and enters channel 105 (not shown in this view). Additionally and/or alternatively, in various example embodiments, air inlet(s) 203 is an example of openings 103 (FIG. 1). The position of air inlet(s) 203 may be varied, and the location, length, and size of channel 105 (FIG. 1) may also be varied based on the location of air inlet(s) 203. Channel 105 (FIG. 1) guides the air around and over puff sensor 123, into cavity 105a, where negative pressure forms as the air continues to be pulled into opening 105b of heating assembly holder 170. A membrane of puff sensor 123 deforms in response to the negative pressure cavity 105a, activating a transistor or other switching element, thereby connecting power from rechargeable battery assembly 150 to heating assembly 130. In at least one embodiment, puff sensor 123 will disconnect power upon completion of a draw, of after a maximum draw duration.

In various example embodiments, a pre-vapor formulation is stored in tank 260, and may be absorbed by cylindrical absorbent 160. Heating assembly 130 wicks pre-vapor formulation from tank 260 and/or cylindrical absorbent 160, and in response to puff sensor 123 connecting power to heating assembly 130, heats the wicked pre-vapor formulation to generate an inhalable dispersion. The inhalable dispersion is pulled through opening 105c of heating assembly cover 140, and out opening 201 in outer housing 110.

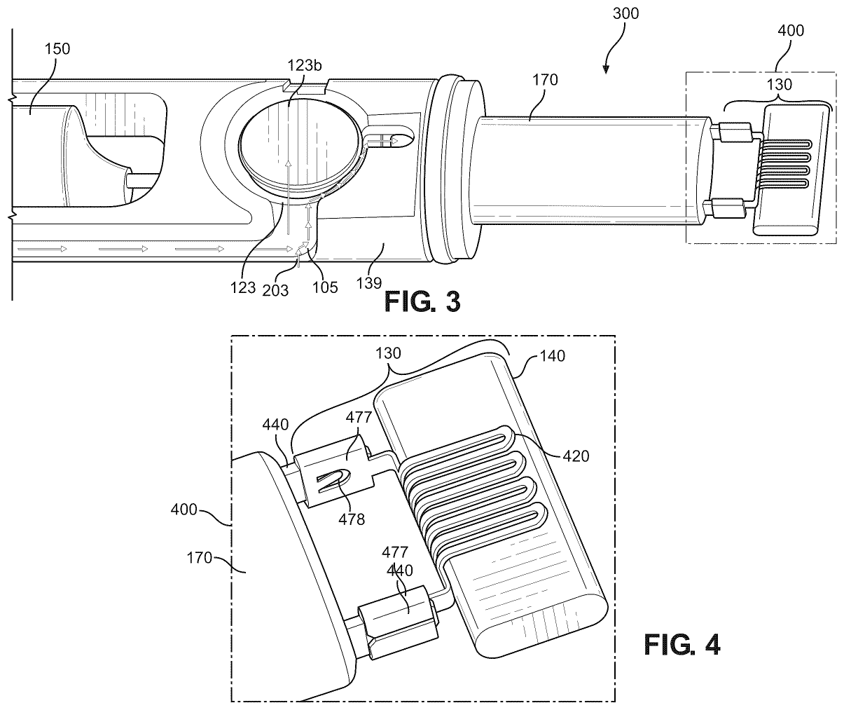

Referring next to FIG. 3, a portion of an internal e-vaping assembly 300 will be discussed in accordance with various example embodiments. In some example embodiments, the portion of internal e-vaping assembly 300 includes: rechargeable battery assembly 150 configured to be housed in heating base 139, which includes puff sensor 123 coupled between rechargeable battery assembly 150 and heating assembly 130. In some example embodiments, heating base 139 includes channel 105 configured to channel air drawn into e-vaping assembly 300 from air inlet 203 and/or other openings (not illustrated), past puff sensor 123, and on to heating assembly 130. In various example embodiments, puff sensor 123 includes membrane 123b configured to deform in the presence of a negative pressure created when an e-vaping adult consumer draws air through an air pathway that includes channel 105 and heating assembly holder 170; and heating assembly 130, which is solderlessly connected to power contacts attached to, or otherwise included in, heating assembly holder 170. The solderless connection is illustrated in area 400.

Referring next to FIG. 4 a heating assembly 130 solderlessly connected to power contacts included in a heating assembly holder 170 will be discussed in accordance with various example embodiments. FIG. 4 is an expanded view of area 400 of FIG. 3, which illustrates a top portion of a heating assembly holder 170 including power contacts 440 solderlessly connected to connectors 477 of heating assembly 130. Heating assembly 130 includes wick 410, held within heating element 420 and configured to wick pre-vapor formulation from a tank (not illustrated).

In at least one example embodiment, wick 410 may include one or more sheets of material, such as a sheet formed of borosilicate fibers. The sheet of material may be folded, braided, twisted, adhered together, etc. to form the wick 4100. The sheet of material may include one or more layers of material. The sheet of material may be folded and/or twisted. If multiple layers of material are included, each layer may have a same density or a different density than other layers. The layers may have a same thickness or a different thickness. The wick 410 may have a thickness ranging from about 0.2 mm to about 2.0 mm (e.g., about 0.5 mm to about 1.5 mm or about 0.75 mm to about 1.25 mm). In at least one example embodiment, the wick 90 includes braided amorphous silica fibers.

In some example embodiments, heating element 420 and integral connectors 477 formed together, as a single, unitary piece. In various example embodiment, heating element 420 has a “taco shell” shape including three sides in contact with wick 410. The three sides of the taco shell shaped heating element may be formed of a continuous, single serpentine length of wire or conductive material, such as a nickel-chromium alloy. Some example embodiments may include a heating element as described in U.S. Pat. No. 10,575,560 issued on Mar. 3, 202 to Tucker, et al., the entire contents of which is hereby incorporated herein by reference. Other example embodiments may include a heating element as described in U.S. patent application Ser. No. 15/729,909, filed on Oct. 11, 2017 and entitled, “Folded Heater For Electronic Vaping Device,” to Holtz et al., the entire contents of which is hereby incorporated herein by reference.

In at least one example embodiment, integral connectors 477 include guide portions in the form of sleeves, and power contacts 440 include complementary guide portions in the form of blades sized to fit snugly within the sleeve. Integral connectors 477 also include locking portions 478 in the form of elastically compressible tabs extending from an inner surface of the sleeves, and power contacts 440 include complementary locking portions in the form of through holes formed in the blades. In various example embodiments, the tabs included on sleeve portions of integral connectors 477 are biased towards the inside of the sleeve portions, so that when a sleeve is slid over a blade, the tab elastically compresses until it is in position over the hole in the blade, at which point the tabs return to their original biased position, thereby locking the sleeve to the blade.

In at least one example embodiment, the guide portion and the complementary guide portion cooperate to guide the first electromechanical contact into locking engagement with the second electromechanical contact, and the locking portion and the complementary locking portion cooperate to form a solderless electromechanical connection that locks the first electromechanical contact into a fixed position relative to the second electromechanical contact.

In the illustrated example embodiment, the sleeve and the blade cooperate to guide the sleeve into position on the blade, and the elastically compressible tab springs into locking engagement with the through hole in the blade in response to the first electromechanical contact reaching a locking engagement position.

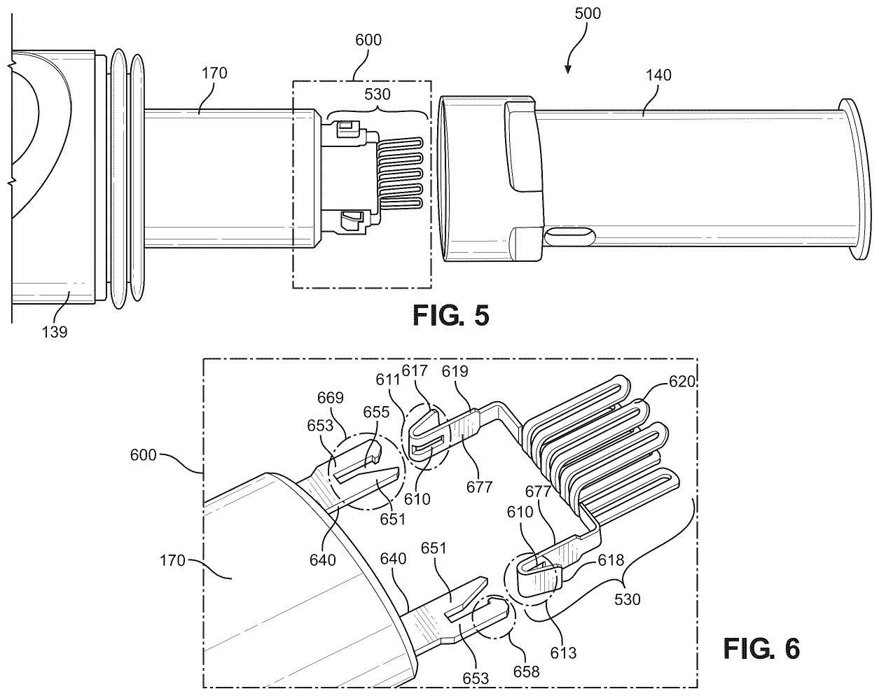

Referring next to FIG. 5 a portion of an alternate internal e-vaping assembly will be discussed in accordance with various example embodiments. In some example embodiments, the portion of an alternate internal e-vaping assembly 500 includes: heating base 139; heating assembly 530, which is solderlessly connected to power contacts attached to, or otherwise included in, heating assembly holder 170, and heating assembly cover 140. When mated to each other, heating assembly cover 140 and heating assembly holder 170 form a two-piece rigid airway tube covering heating assembly 530, and provide an airpath for an inhalable dispersion generated by heating assembly 530 to be delivered to an e-vaping adult consumer. The solderless connection is illustrated in area 600.

Referring next to FIG. 6, a heating element 620 of a heating assembly 530 solderlessly connected to power contacts 640 included in a heating assembly holder 170 using connectors formed as an integral part of a heating element 623 will be discussed in accordance with various example embodiments. In various example embodiments, heating element 620 has a “taco shell” shape including three sides formed of a continuous, single serpentine length of wire or conductive material, such as a nickel-chromium alloy. Heating element 620 is similar to heating element 420 (FIG. 4), except for the shape of integral connectors 677.

In at least one example embodiment, integral connectors 677 include guide portions in the form of guide openings 610. In some example embodiments, a first flattened, elongated end 611 of an integral connector 677 is formed to include an elastically compressible V-shaped portion 613 with two sides 617 and 619, the guide opening may be formed in at least one of the two sides. In some example embodiments, power contacts 640 include complementary guide portions in the form of a tapered side 651 of a slot 655 formed in a flattened and elongated end 669 of power contacts 640.

Integral connectors 677 may also include locking portions in the form of the free ends 618 of the elastically compressible V-shaped portions 613 of integral connectors 677. Power contacts 640, may include complementary locking portions in the form of a protrusion 658 on a second side 653 of the slot 655. In some such embodiments, the V-shaped portions 613 elastically compress in response to being guided into the slots 655 of power contacts 640 by the guide opening 610 and the tapered side 651. The protrusions 658 snap over the termination of the free sides 618 of the V-shaped portions 613 in response to the first integral connectors 677 reaching a locking engagement position.

In at least one example embodiment, the guide portion 610 and the complementary guide portion 651 cooperate to guide the first electromechanical contact, e.g. an integral connector 677 into locking engagement with the second electromechanical contact, e.g. a power contact 640, while the locking portion 617 and the complementary locking portion 658 cooperate to form a solderless electromechanical connection that locks the first electromechanical contact into a fixed position relative to the second electromechanical contact. Note that in at least some example embodiment, guide portion 610 and complementary guide portion 651 provide locking engagement in addition to locking portion 617 and complementary locking portion 658.

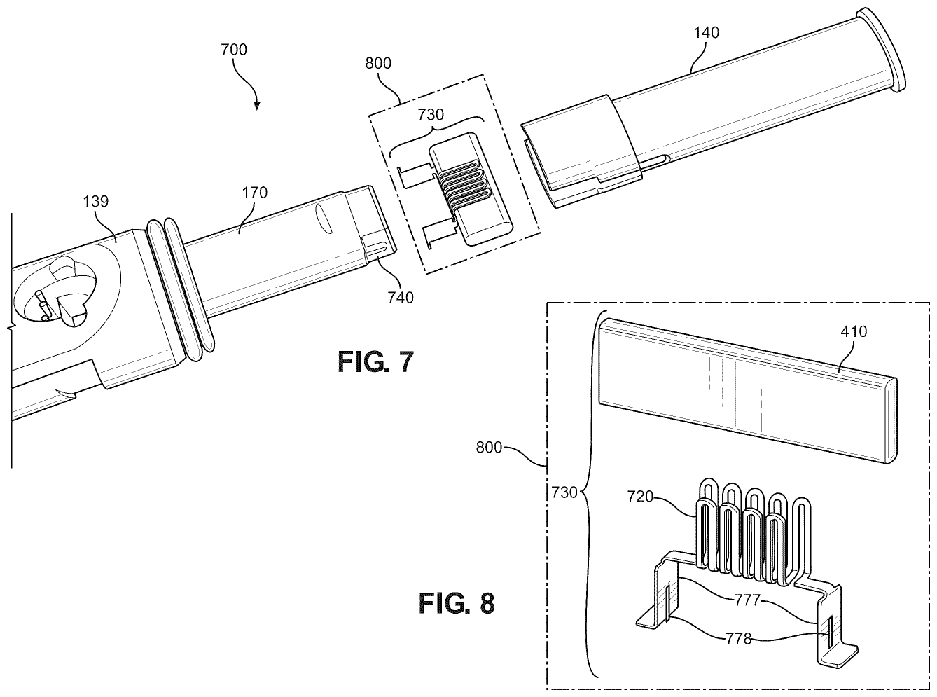

Referring next to FIG. 7 another internal e-vaping assembly 700 will be discussed in accordance with various example embodiments. In some example embodiments, the illustrated portion of internal e-vaping assembly 700 includes: heating base 139; heating assembly 730, which is solderlessly connected to power contacts 740 attached to, or otherwise included in, heating assembly holder 170, and heating assembly cover 140. The solderless connection is illustrated in area 800.

FIG. 8 is an exploded view of a heating assembly 730, which in various example embodiments includes wick 410 constructed of fiber wicking material, and a stamped nickel-chromium alloy heating element 720, which may be solderlessly connected to power contacts 740 included in heating assembly holder 170 using slots 778 formed in integral connectors 777. In various example embodiments, slots 778 may be formed in the same stamping operation used to form stamped nickel-chromium alloy heating element 720. In some example embodiments, slots 778 may be etched or cut into the integral connectors using a separate process. In some example embodiments, slots 778 may be straight, angled, beveled, or have a shape other than the strictly rectangular shape shown. For example, slots 778 may be star shaped, rounded, or in another shape that corresponds to a shape of power contacts 740, and is designed to securely mate and lock with power contacts 740 to form a secure, solderless electro-mechanical connection. In at least one example embodiment, as integral connectors 777 slide over power contacts 740, power contacts 740 are received in slots 778 to provide a friction fit securing heating element 720 in place while provide electrical contact.

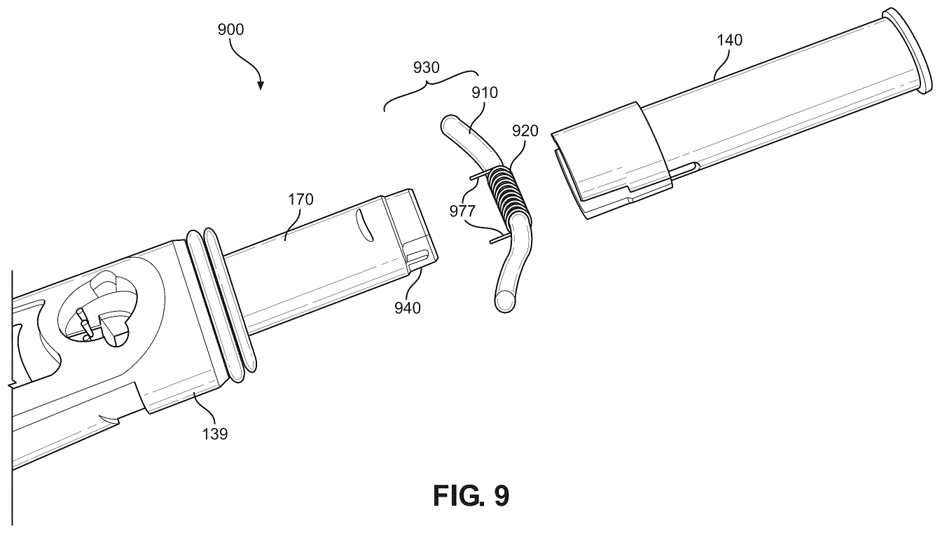

Referring next to FIG. 9 an internal e-vaping assembly 900 will be discussed in accordance with various example embodiments. In some example embodiments, internal e-vaping assembly 900 includes: heating base 139; heating assembly cover 140, heating assembly 930, which includes heating element 920 with integral ends 977, and a roll-type wick 910. Roll-type wick 910 is an alternate embodiment of a pillow- or sandwich-type wick 410. In the illustrated embodiment, heating element 920 is wrapped helically about roll-type wick 910, but like the heating elements discussed with reference to other example embodiments, may also heat pre-vapor formulation absorbed into roll-type wick 910 to generate an inhalable dispersion.

In various example embodiments, integral ends 970 may be solderlessly connected to power contacts 940 included in, or attached to, heating assembly cover 140 by friction. For example, a spacing between power contacts 940 and a molded body of heating assembly cover 140 may be just sufficient to allow integral ends 970 to be forced into locking friction engagement with power contacts 940. In other example embodiments, power contacts 940 may include oblong openings into which integral ends 970 are pushed, wherein the oblong openings deform to lock integral ends into a secure solderless connection. In some example embodiments, power contacts 940 can include earring-like post backs that lock integral ends 970 into place once engaged.

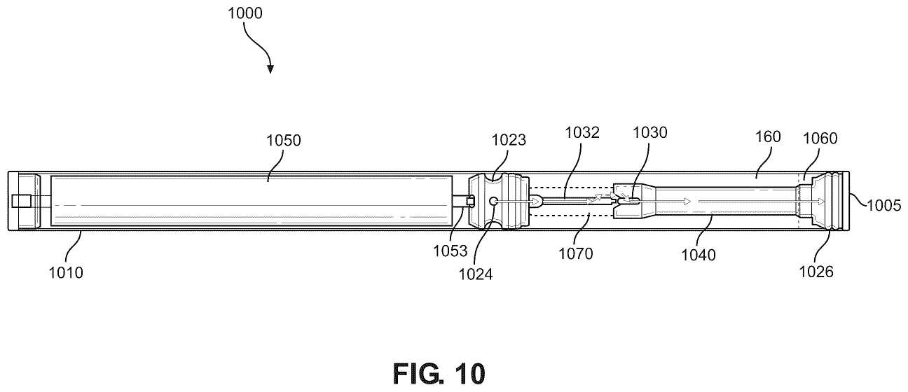

Referring next to FIG. 10 a see-through side view of an assembled e-vaping device will be discussed in accordance with various example embodiments. In various example embodiments, e-vaping device 1000 includes battery assembly 1050, flexible seal 1023, outer housing 1010 including an air inlet 1024 and an inhalable dispersion outlet 1005 through which an e-vaping adult consumer draws, cylindrical absorbent 160 surrounding a two-piece rigid airway tube formed by heating assembly holder 1070 and heating assembly cover 1040. In at least some example embodiments, cylindrical absorbent 160 substantially fills a reservoir, or tank 1060, formed between outer housing 1010 and the two-piece rigid airway tube. In some example embodiments, an exit seal 1026 is provided at the end of tank 1060 opposite seal 1023.

In various example embodiments, e-vaping device 1000 also includes a heating assembly, which includes a wick extending through a wick opening 1030 formed by aligned slots in the heating assembly holder 1070 and heating assembly cover 1040, so that the wick of the heating assembly contacts the cylindrical absorbent 160 to absorb pre-vapor formulation stored in the.

In various example embodiments, power from battery assembly 1050 is connected to a puff sensor (not visible in this view) inserted into a battery-facing end of seal 1023 via power bar 1053, and the puff sensor provides switched power to a heating assembly (not visible in this view) located near wick opening 1030 via elongated connector 1032 that passes through seal 123 to reach the contacts of the puff sensor. As illustrated by the white arrows, in response to a draw at inhalable dispersion outlet 1005, air is drawn through air inlet 1024 in outer housing 1010, flows through channels in seal 1023 (not visible in this view), through an inner passage of heating assembly holder 1070, around the heating assembly near wick opening 1030, and out inhalable dispersion outlet 1005. Air entering air inlet 1024 forms a negative pressure at a sensing side of the puff sensor mounted in seal 1023, which causes the puff sensor to apply power to the heating assembly. When power is applied to the heating assembly, the heating assembly heats pre-vapor solution held in a wick of the heating assembly, thereby generating an inhalable dispersion from the pre-vapor formulation. The inhalable dispersion is entrained in the airflow through an internal passage of heating assembly cover 1040 to inhalable dispersion outlet 1005.

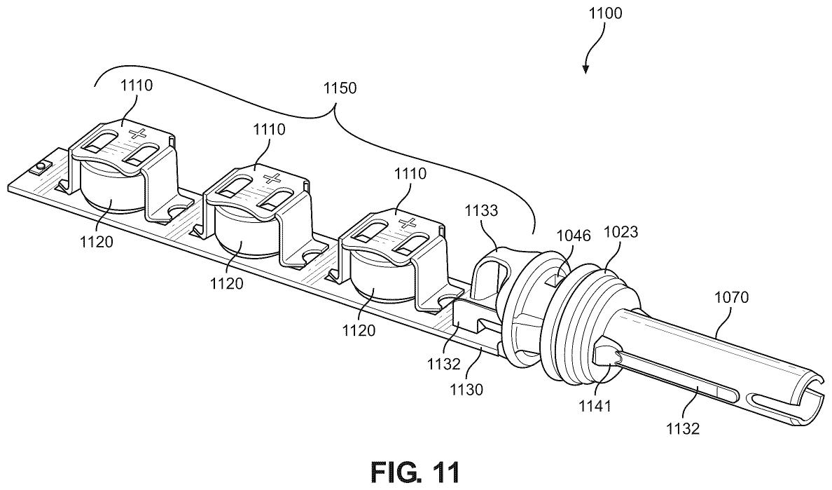

Referring next to FIG. 11, a portion of an internal e-vaping assembly 1100 will be discussed in accordance with various example embodiments. In the illustrated example embodiment, the portion of internal e-vaping assembly 100 includes replaceable battery assembly 1150, including printed circuit board assembly (PCBA) 1130, battery contacts 1110 mounted on PCBA 1130 and holding replaceable batteries 1120, and flat power conductor 1132. In various example embodiments, replaceable battery assembly 1150 is an alternate embodiment of battery assembly 1050 (FIG. 10).

Although not illustrated, a corresponding power conductor may be located on the hidden side of replaceable battery assembly 1150. In some example embodiments, flat power conductor 1132 may be attached to the positive side of the batteries, and circular conductor 1133 may be attached to the negative side of batteries 1120. In various example embodiments, circular conductor 1133 may surround and engage an outside case of a puff sensor mounted in seal 1023 (not visible in this view) to provide a ground, while flat power conductor 1132 is connected to a non-grounded terminal of the puff sensor.

In various example embodiments, PCBA 1130 is coupled to heating assembly holder 1070 via flexible seal 1023, which in at least some example embodiments isolates battery assembly 1150 from an airpath that includes heating assembly holder 1070. In various example embodiments, flexible seal 1023 includes conductor passages allowing flat power conductors 1132 to reach and connect to a heating assembly, while forming a seal about flat power conductors 1132. Flexible seal 1023 may also include seal air inlet 1046, which allows outside air to be drawn into the airpath that includes heating assembly holder 1070 via an air inlet in an outer housing (not illustrated). In at least one example embodiment, a heating assembly connects solderlessly to flat power conductors 1132.

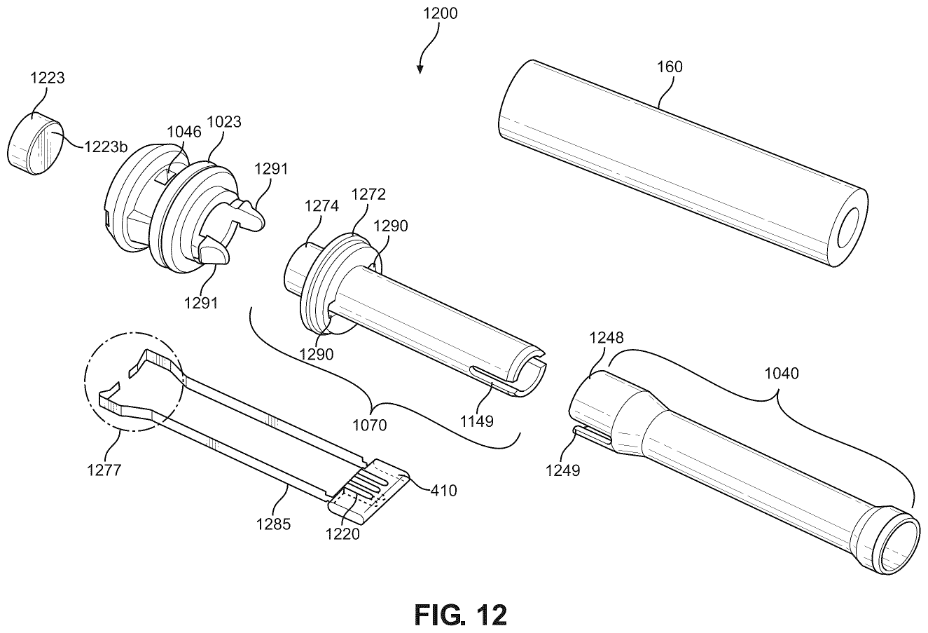

Referring next to FIG. 12 an upper e-vaping assembly 1200 will be discussed in accordance with various example embodiments. In various example embodiments, upper e-vaping assembly 1200 includes heater assembly holder 1070 including seal engagement portion 1274, and graduated adapter 1272. Graduated adapter 1272 may include seal engagement slots 1290 that receive seal tabs 1291 and lock seal 1023 in place. Heater assembly holder 1070 may also include a heating-assembly-cover-mating-end including holder slot 1149, heater assembly cover 1140 including flared mating end 1248, which includes a cover slot 1249. In various example embodiments, holder slot 1149 and cover slot 1249 align to form a wick opening when heating assembly cover 1040 is mated with heating assembly holder 1070.

In various example embodiments, flexible seal 1023 mates with seal engagement portion 1274 of heater assembly holder 1170, and houses pressure/puff sensor 1223 within a sensor cavity of the flexible seal (not visible in this view). In various example embodiments, a sensing membrane 1223b of pressure/puff sensor 1223 faces into seal 1023. In some example embodiments, upper e-vaping assembly 1200 also includes a cylindrical absorbent 160 positioned about a two-piece rigid airway formed by combining heating assembly holder 1070 and heating assembly cover 1040.

In various example embodiments, upper e-vaping assembly 1200 also includes a heating assembly including a wick 410 and a heating element 1220 including integral elongated legs having 90 degree “L shaped” bends 1277

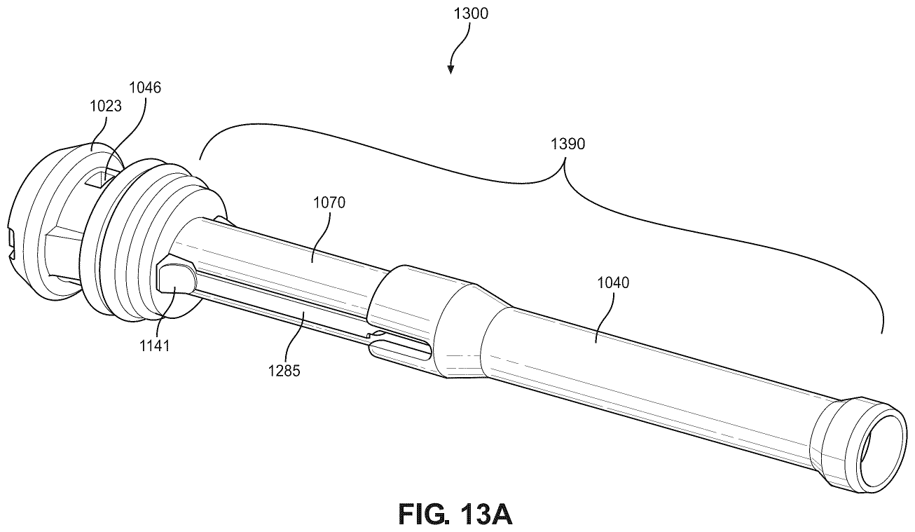

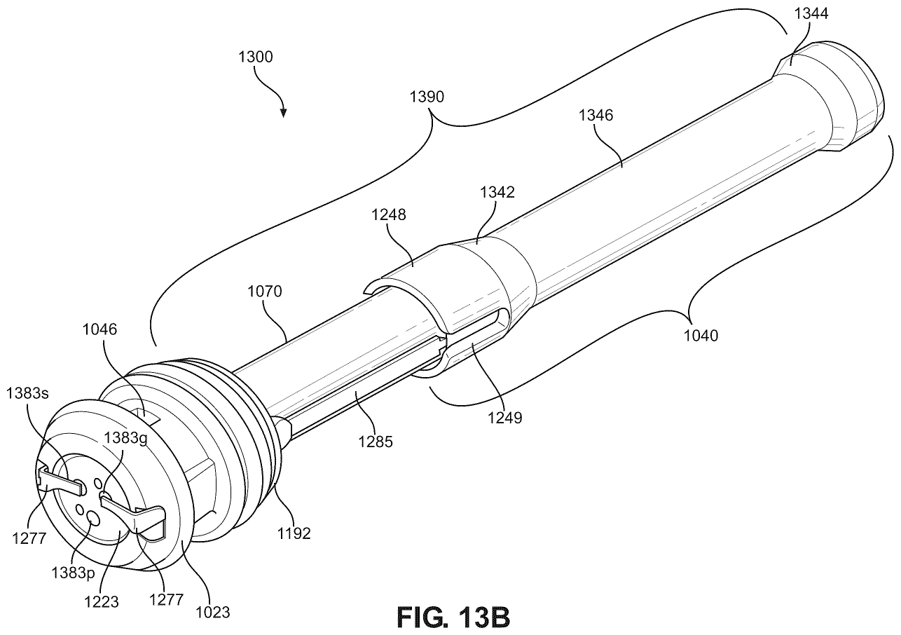

Referring next to FIG. 13A an upper e-vaping assembly 1300 will be discussed in accordance with various example embodiments. Upper e-vaping assembly 1300 includes flexible seal 1023, including seal air inlet 1046 and seal tabs 1141 locked to heating assembly holder 1070, and heating assembly cover 1040. Heating assembly holder 1070, and heating assembly cover 1040 connect to form a two-piece rigid airway tube 1390. As illustrated, upper e-vaping assembly 1300 also includes flat conductor 1285, which in some example embodiments may be an elongated conductive leg integral to a heating element.

Referring next to FIG. 13B upper e-vaping assembly 1300 will be further discussed in accordance with various example embodiments. Upper e-vaping assembly 1300 includes flexible seal 1023, heating assembly holder 1070 and heating assembly cover 1040, which connect to form a two-piece rigid airway tube 1390 configured to provide an airpath providing an inhalable dispersion to an e-vaping adult consumer. In various example embodiments, the two-piece rigid airway tube 1190 may be coupled to a heating base (not illustrated) using flexible seal 1023.

In various example embodiments, heating assembly holder 1070 includes a first end configured to engage the heating assembly cover 1170, and a second end distal from the first end and configured to engage the flexible seal 1023. In some example embodiment, the heating assembly holder includes a graduated adapter 1192 formed on its outer surface proximate to the second end of the heating assembly holder that engages the flexible seal 1023.

In various example embodiments, the heating assembly cover 1040 includes a mouthpiece end 1344, a main body 1346, and a flared mating end 1248 configured to engage the heating assembly holder 1070. Flared mating end 1248 may include a slot 1249. In some such example embodiments, a slot in the heating assembly holder aligns with a slot included in the heating assembly cover when the two-piece rigid airway tube 1390 is assembled.

In various example embodiments, upper e-vaping assembly 1300 includes an elongated conductive legs 1285 integral to a heating element included in a heating assembly housed within two-piece rigid airway tube 1390. In the illustrated example embodiments, upper e-vaping assembly 1300 also includes pressure sensor 1223, sometimes referred to as a puff sensor, which includes switched contact 1383S, positive contact 1383P, and ground contact 1383G. In various example embodiments, positive battery power may be connected to positive contact 1383P, and ground contact 1383G may be connected to ground. Switched contact permits power to flow from positive contact 1383P to switched contact 1383S in response to detection of a puff. For example, a membrane 1223b (FIG. 12) of pressure sensor 1223 may deform in response to negative pressure caused by an adult consumer drawing through an e-vaping device, as discussed elsewhere herein. Deformation of membrane 1223b activates a switch, such as a power transistor within pressure sensor 1223, making an electrical connection internal to pressure sensor 1223 that connects positive contact 1383P to switched contact 1383S, thereby allowing positive battery power to flow through switched contact 1383S. In the illustrated example embodiment, elongated conductive legs 1285 include 90 degree bends 1277 extending over an exposed face of the pressure sensor 1223, and directly contacting switched contact 1383S and ground contact 1383G on the exposed face of the pressure sensor 1223 to establish a solderless connection. In operation, when pressure sensor 1223 connects positive contact 1383P to switched contact 1383S in response to detecting a puff, positive battery power enters positive contact 1383P through an electrical connection (not illustrated in FIG. 13B), flows through the conductive leg 1285 coupled to switched contact 1383S, through the heating element (not visible in this view), and back through the other conductive leg 1285 to ground contact 1383G. In at least one example embodiment, pressure sensor 1223 receives its own operating power through positive contact 1383P and ground contact 1383G. In the illustrated embodiments, a sensing membrane of the pressure sensor is facing into seal 1023, and is in fluid communication with seal air inlet 1046.

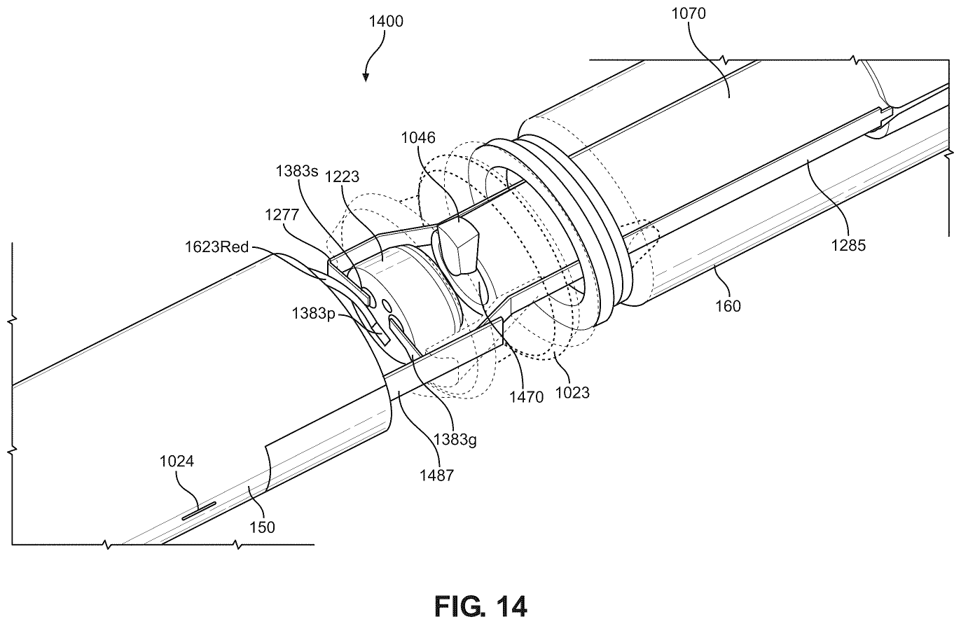

Referring next to FIG. 14, an e-vaping device 1400 will be discussed in accordance with various example embodiments. E-vaping device 1400 includes battery assembly 1050 coupled to provide battery power to pressure sensor 1223, which provides switched power to elongated conductive legs 1285 of a heating assembly (not illustrated) as discussed previously with respect to FIG. 13B. In the illustrated embodiment, a power ground is connected to one of the elongated legs 1285 and to ground contact 1383G of pressure sensor 123 via electrical contact 1487, positive battery power is connected to positive contact 1383P of pressure sensor 123 via wire 1623Red, and switched positive battery power is connected to another leg 1285 via switched contact 1383S of puff sensor 1223. In the illustrated example embodiment, elongated conductive legs 1285 include 90 degree bends 1277 extending over the exposed face of pressure sensor 1223. Various example embodiments also include cylindrical absorbent 160 surrounding heating assembly holder 1070, which defines an air passage 1470. Note that air inlet 1024 may be positioned near the center of seal 1023, and in fluid communication with seal air inlet 1046, when placed in its final assembled position.

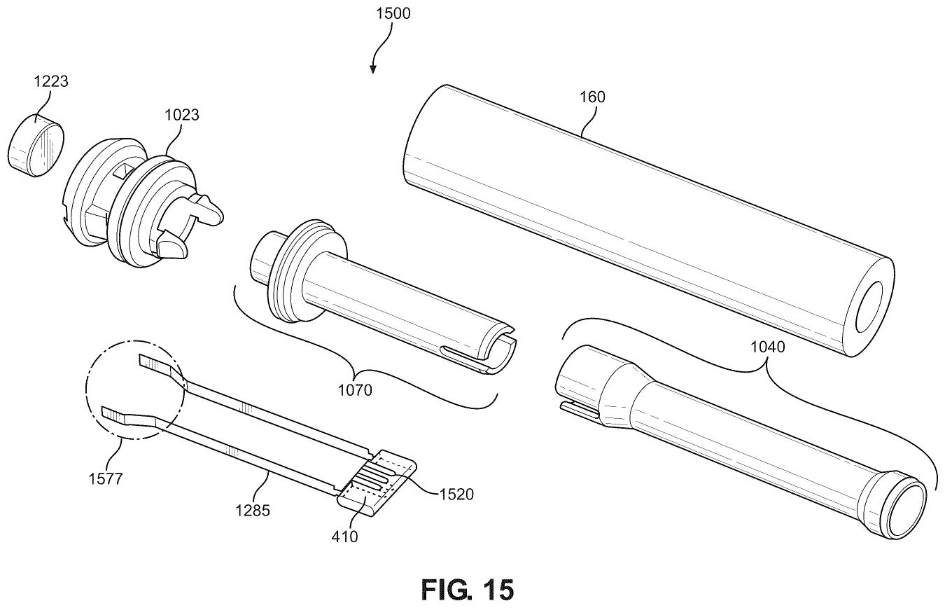

Referring next to FIG. 15, an upper e-vaping assembly will be discussed in accordance with various example embodiments. In various example embodiments, upper e-vaping assembly 1500 includes the same or similar elements discussed in relation to upper e-vaping assembly 1200 illustrated in FIG. 12, with the exception of the ends 1577 of integral elongated legs 1285, which do not have a 90 degree bend.

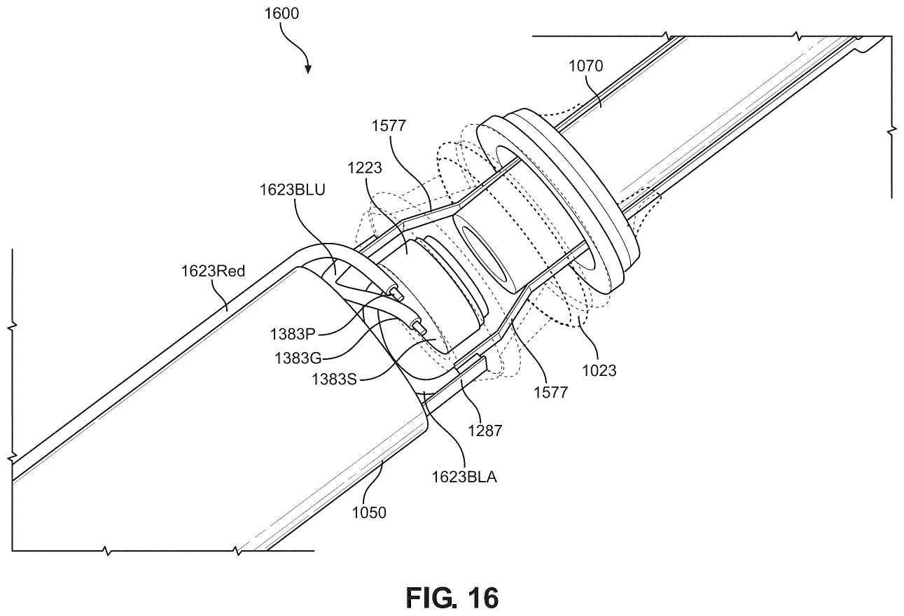

Referring next to FIG. 16 an e-vaping device will be discussed in accordance with various example embodiments. E-vaping device 1600 includes battery assembly 1050 coupled to provide battery power to pressure sensor 1223 via wires 1623, and to one of the elongated conductive legs 1577 of a heating assembly (not illustrated). In the illustrated example embodiment, elongated conductive legs 1577 are straight, and do not extend over the exposed face of pressure sensor 1180. A connection to ground is provided via electrical contact 1287, which is coupled to wire 1623BLA and one of the elongated conductive legs 1577. Wire 1623BLA is also coupled to ground contact 1383G of pressure sensor 1223. Wire 1623BLU is coupled between switched contact 1383S of pressure sensor 1223, and the other elongated conductive leg 1577, and wire 1623Red connects positive batter power to positive contact 1383P.

Note that the rotational orientation of pressure sensor 1223 is rotated in comparison to the pressure sensor 1223 illustrated in FIG. 14. In particular, the contacts have been rotated clockwise, by one position. So, for example, positive contact 1383P is positioned on the left side of the diagram in FIG. 16, whereas in the diagram of FIG. 14 positive contact 1383P is located at the bottom. Power flow in FIG. 16 is the same as that previously discussed, except that wires are used to couple elongated conductive legs 1577 to the contacts of pressure sensor 1223.

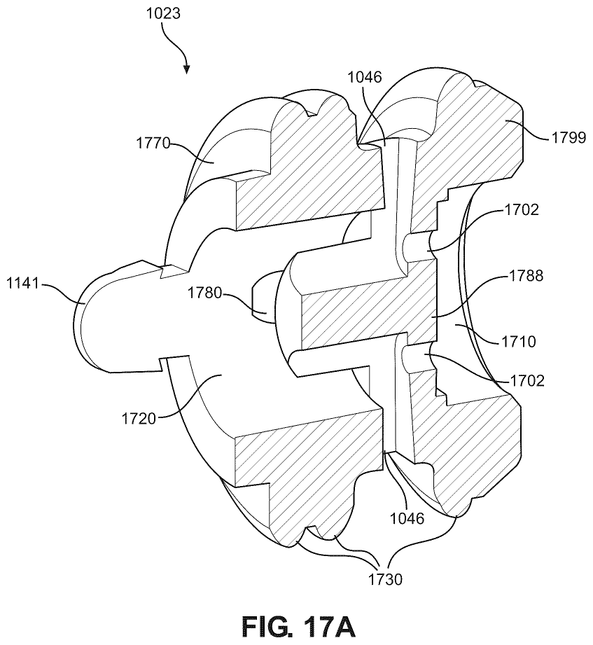

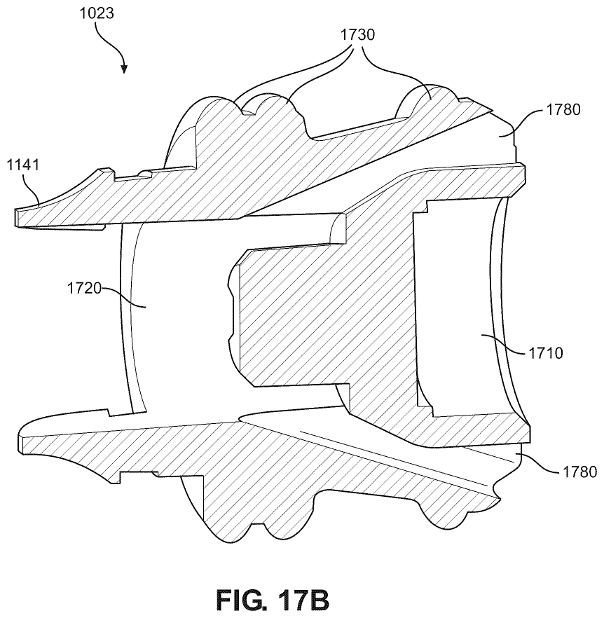

Referring next to FIGS. 17A and 17B, which illustrate different cross sections of an e-vaping device seal 1023, will be discussed in accordance with various example embodiments. In various example embodiments, flexible seal 1023 includes a sensor cavity 1710 in fluid communication with an air passage 1720 via negative pressure ports 1702. A pressure sensor with flexible membranes may be aligned with the membrane facing negative pressure ports 1702.

In various example embodiments, flexible seal 1023 includes seal air inlets 1046, which communicate with a housing inlet to permit air to be pulled through air passage 1720 and into a passage formed by two-piece rigid airway tube 1390 during an adult consumer's draw. Air flowing through seal air inlets 1046 and air passage 1720 generates a negative pressure that may be sensed by a pressure sensor mounted in sensor cavity 1710. In various example embodiments, the shape of sensor cavity 1710 may conform to a shape and form factor of a pressure sensor to be mounted therein. A pressure sensor included in various example embodiments here in is cylindrical, which matches the illustrated shape of sensor cavity 1710.

A shape, size, configuration, and number of seal air inlets 1046 may, in some example embodiments, be adjusted to achieve a desired airflow resistance, e.g. a resistance to draw, a desired amount of airflow, and/or to achieve other design goals. In the illustrated example embodiments, two seal air inlets 1046 are included in seal 1023. The inlets in the illustrated example embodiments taper from wider at the edge of seal 1023 to narrower as they proceed towards the center of seal 1023. In other example embodiments, seal air inlets 1046 may be oval, have rounded edges, include internal ribs, include flaps, or the like.

In some example embodiments, flexible seal 1023 includes a sealing surface 1779 used to form a seal at an interface of a heating base and the flexible seal 1023. In some example embodiments, flexible seal 1023 includes another sealing surface 1770 used to form a seal at an interface of the two-piece rigid airway tube and the flexible seal. In yet further example embodiments, flexible seal 1023 includes yet another sealing surface 1788 forming a third seal at an interface of the air passage included in the flexible seal and the pressure sensor inserted into the sensor cavity. As illustrated, seal tabs 1141 may be located near sealing surface 1770 to lock the seal to the two-piece rigid airway. In other example embodiments, seal tabs 1141 may additionally or alternatively be placed near sealing surface 1779.

In some example embodiments, flexible seal 1023 has a “dumbbell” shape, and includes a plurality of elastic sealing ribs 1730 configured to seal a pre-vapor solution tank formed between an outer housing and a two-piece rigid airway tube. Although 3 sealing ribs are illustrated, more or fewer sealing ribs having the same or different circumferences may be included. In addition, a spacing between ribs may be altered, and the relative location of sealing ribs 1730, seal air inlets 1046, and other openings may be altered.

In some example embodiments, flexible seal 1023 also includes conductor passages 1780 configured to receive elongated conductive legs or other conductors, allowing the conductors to pass through the seal 1023, while still providing a seal around the elongated conductive legs or other conductors. A tip of a conductor passage 1780 is illustrated in FIG. 17A, while a full length of the conductor passages 1780 is shown in FIG. 17B. The shape, size, and number of conductor passages can be altered in various example embodiments to provide proper sealing for conductors passing through seal 1023 to reach power on the opposite side. Illustrated conductor passages 1780 may be used to permit sealed passage of various configurations of elongated conductive legs used to provide power to a heating assembly in various example embodiments.

It should be understood that the shape of the battery (or batteries) for the power supply may vary. For example, the battery may be cylindrical, prismatic, disc-shaped, a pouch battery, or any other variation of battery shape known in the art. Additionally, it should be understood that the battery may be any of a variety of types. For example, in one embodiment, the battery may be a rechargeable battery (e.g., lithium-ion). In another embodiment, the battery may be a non-rechargeable battery (e.g., alkaline). In yet another embodiment, the battery may include silver oxide, carbon zinc, cadmium, nickel, or any another material known in the art. Furthermore, the battery may include a primary cell and/or a secondary cell. It will be understood by those of ordinary skill in the art that various changes in form and details of the battery may be made without departing from the spirit and the scope of the invention.

As used herein, a pre-vapor formulation refers to, in various embodiments, a substance (e.g., liquid, wax, gel) that may be transformed into a vapor. For example, the pre-vapor formulation may include, but is not limited to, water, solvents, active ingredients, ethanol, plant extracts, natural or artificial flavors, and/or vapor formers such as glycerin and propylene glycol.

It will be understood that plant extracts may include active ingredients as well as their supporting counterparts (e.g., compounds which assist in the absorption of an active ingredient). Active ingredients may include, but are not limited to, nicotine (tobacco derived nicotine, synthetic nicotine, etc.), caffeine, and/or any number of plant extracts including extracts of medicinal plants. Tobacco derived nicotine may be derived from any member of the genus Nicotiana, including one or more species of tobacco plants, such as Nicotiana rustica and Nicotiana tabacum, and may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The extract of a medicinal plant may be a naturally occurring constituent or extract of a medicinal plant that has a medically accepted physiological effect (e.g., therapeutic effect, prophylactic effect). For instance, the medicinal plant may be a cannabis plant or a cannabimimetic plant (i.e., a plant with similar pharmacological effects to those of cannabis). For a cannabis plant, the compound may be a cannabinoid. Cannabinoids interact with receptors in the body to produce a wide range of effects. As a result, cannabinoids have been used for a variety of medicinal purposes (e.g., treatment of pain, nausea, epilepsy, psychiatric disorders). For a cannabimimetic plant, the compound may be a cannabimimetic agent. Cannabimimetic agents interact with receptors in the body to produce similar pharmacological effects as cannabinoids.

Examples of cannabinoids include tetrahydrocannabinolic acid (THCA), tetrahydrocannabinol (THC), cannabidiolic acid (CBDA), cannabidiol (CBD), cannabinol (CBN), cannabicyclol (CBL), cannabichromene (CBC), and cannabigerol (CBG). Tetrahydrocannabinolic acid (THCA) is a precursor of tetrahydrocannabinol (THC), while cannabidiolic acid (CBDA) is precursor of cannabidiol (CBD).

In some example embodiments, in addition to active ingredients, the pre-vapor formulation may include flavorants from natural and/or artificial sources, such as plant extracts (e.g., tobacco extract, cannabis extract, cannabimimetic extract), menthol, mint, and/or vanilla.

It should be understood that when an element or layer is referred to as being “on,” “connected to,” “coupled to,” “attached to,” “adjacent to,” or “covering” another element or layer, it may be directly on, connected to, coupled to, attached to, adjacent to or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

While the term “same” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., +10%).

When the terms “about” or “substantially” are used in this specification in connection with a numerical value, it is intended that the associated numerical value includes a manufacturing or operational tolerance (e.g., +10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., +10%) around the stated numerical values or shapes.

The controller may include processing circuitry such as hardware including logic circuits; a hardware/software combination such as a processor executing software stored in a memory; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

What is claimed is:

1. An e-vaping device comprising:
a heating base coupled to provide power for the e-vaping device;
a flexible seal;
a two-piece rigid airway tube coupled to the heating base by the flexible seal, the two-piece rigid airway tube forming an airpath providing an inhalable dispersion; and
a heating assembly housed within the two-piece rigid airway tube and including
a wick in fluid communication with a tank holding a pre-vapor formulation, and
a heating element configured to heat the pre-vapor formulation in the wick to generate the inhalable dispersion.

2. The e-vaping device of claim 1, wherein the two-piece rigid airway tube comprises:
a heating assembly cover; and
a heating assembly holder including a first end engaging the heating assembly cover, and a second end distal from the first end engaging the flexible seal, the first end of the heating assembly holder including a first slot aligned with the wick.

3. The e-vaping device of claim 2, wherein the first end of the heating assembly holder comprises:
a graduated adapter formed on an outer surface of the heating assembly holder.

4. The e-vaping device of claim 2, wherein the heating assembly cover comprises:
a flared mating end engaging the heating assembly holder, the flared mating end defining a second slot, the second slot aligning with the first slot included in the heating assembly cover.

5. The e-vaping device of claim 2, wherein the heating assembly comprises:
elongated conductive legs long enough to reach from a bottom of the first slot in the first end of the heating assembly holder to a bottom of the flexible seal.

6. The e-vaping device of claim 5, further comprising:
a pressure sensor including electrical contacts, and mounted in a sensor cavity of the flexible seal, the pressure sensor configured to selectively provide power from a power supply to the electrical contacts in response to a change in pressure indicating a requested draw; and
wherein the elongated conductive legs are electrically coupled to the electrical contacts included in the pressure sensor.

7. The e-vaping device of claim 6, wherein
the electrical contacts included in the pressure sensor are located on an exposed face of the pressure sensor,
the elongated conductive legs of the heating assembly include free ends distal from the wick, and
a free end of at least one of the elongated conductive legs includes a 90 degree bend extending over the exposed face of the pressure sensor and directly contacting at least one of the electrical contacts on the exposed face of the pressure sensor to establish a solderless connection.

8. The e-vaping device of claim 6, wherein
the electrical contacts included in the pressure sensor are located on an exposed face of the pressure sensor,
the elongated conductive legs of the heating assembly include free ends distal from the wick, and
wires attached to the electrical contacts on the exposed face of the pressure sensor are further attached to the free ends of the elongated conductive legs.

9. The e-vaping device of claim 5, wherein
the elongated conductive legs of the heating assembly are formed as an integral part of a heating element included in the heating assembly.

10. The e-vaping device of claim 9, wherein
the elongated conductive legs and the heating assembly are formed as a unitary piece by a metal stamping process.

11. The e-vaping device of claim 5, wherein the flexible seal defines conductor passages holding the elongated conductive legs, allowing them to pass from a top of the seal to a bottom of the seal, and sealing around the elongated conductive legs.

12. The e-vaping device of claim 1, wherein the flexible seal defines an air passage allowing air to flow through the air passage and into the airpath provided by the two-piece rigid airway tube.

13. The e-vaping device of claim 12, wherein the flexible seal defines a sensor cavity in fluid communication with the air passage, and holding a pressure sensor,
a first sealing surface forming a first seal at an interface of the heating base and the flexible seal,
a second sealing surface forming a second seal at an interface of the two-piece rigid airway tube and the flexible seal, and
a third sealing surface forming a third seal at an interface of the air passage included in the flexible seal and the pressure sensor inserted into the sensor cavity.

14. The e-vaping device of claim 1, further comprising:
an outer housing covering the heating base, the flexible seal, the two-piece rigid airway tube, and a cylindrical absorbent, wherein
the outer housing and the two-piece rigid airway tube form a pre-vapor solution tank, and
the flexible seal includes a plurality of elastic sealing ribs sealing the pre-vapor solution tank.

15. An e-vaping device, comprising:
a two-piece rigid airway tube including a heating assembly holder and a heating assembly cover having mated ends slidingly engaged; and
a heating assembly housed within the two-piece rigid airway tube, proximate to the mated ends of the two-piece rigid airway tube.

16. The e-vaping device of claim 15, further comprising:
a cylindrical absorbent surrounding the two-piece rigid airway tube.

17. The e-vaping device of claim 15, wherein
the heating assembly includes a heating element and a wick; and
the mating ends of the heating assembly holder and the heating assembly cover define a wick opening.

18. The e-vaping device of claim 17, further comprising:
a flexible seal coupled to a bottom end of the heating assembly holder.

19. The e-vaping device of claim 18, wherein the heating element comprises:
elongated conductive legs extending from the wick opening to a bottom of the flexible seal.

20. The e-vaping device of claim 19, wherein the elongated conductive legs are integral to the heating element.
